(19) United States
(12) Patent Application Publication
(10) Pub. No.: US 2009/0168615 A1
(43) Pub. Date: Jul. 2, 2009

(54) PARAMETER ADJUSTING METHOD AND DATA RECORDING/REPRODUCING DEVICE

(76) Inventor: Masatsugu Ogawa, Tokyo (JP)

Correspondence Address: YOUNG & THOMPSON, 209 Madison Street, Suite 500, ALEXANDRIA, VA, 22314, US

(21) Appl. No.: 11/915,424

(22) PCT Filed: May 24, 2006
(86) PCT No.: PCT/JP2006/310325

§ 371 Date: Nov. 26, 2007

(30) Foreign Application Priority Data
May 26, 2005 (JP) 2005-154139

(51) Int. Cl. G11B 7/00

(52) U.S. Cl. 369/44.32; G9B/7

(57) ABSTRACT

A high-density land/groove recording method is provided which records random data used for parameter adjustment on either adjacent three grooves or adjacent three lands of an optical disk. The recorded data is reproduced, the radial tilt is first adjusted based on PRSNR of the reproduction data, and thereafter parameters are adjusted one by one in the order of focus offset, recording power and track offset. The recording power may be adjusted first.

### TECHNICAL FIELD

The present invention relates to a data recording/reproducing device for recording/reproducing data on a high-density optical disk and a data adjustment method for use in recording/reproducing data.

### BACKGROUND ART

An optical disk drive records data on an optical disk or reads recorded data by using an optical head. In the optical disk drive, some parameters exist which specify recording/reproducing conditions affecting the performance of the optical disk drive itself during the recording/reproducing (recording and/or reproducing). The parameters which may be adjusted in the current optical disk drive include a tilt representing an inclined angle between the optical head and the optical disk, a focus offset representing a deviation of the focal point of the optical spot, a track offset representing a deviation of the optical spot with respect to the center of the track to be scanned by the optical spot, an optimum recording power used for recording information data, and so on. The tilt includes a radial tilt which means an inclination of the optical head in the radial direction with respect to the direction perpendicular to the recording surface of the optical disk, and a tangential tilt which means an inclination of the optical head in the direction of the track (direction perpendicular to the radial direction) with respect to the perpendicular to the recording surface of the optical disk.

Known techniques for adjusting the above parameters include one described in Patent Publication JP-1996-45081A. This technique features that a variety of types of recording schemes are used for adjusting respective parameters, and uses a three-track recording scheme which records random data on adjacent three tracks. In this technique, it is premised that the recording signals for adjusting the parameters are recorded in advance on the optical disk. The techniques for adjusting the recording power include one described in Patent Publication JP-2002-163825A, for example. In this technique, specific data are recorded on a trial recording area while changing the recording conditions, and an optimum recording power is selected based on the reproduced signals.

Many of optical disks which are developed in recent years, (for example, HD DVD-RW etc.) do not have the adjustment signals recorded thereon in advance. In such an optical disk, it is necessary for the user side to perform a trial recording of signals for the adjustment. Along with the recent development of higher-density optical disks, however, if the recording is performed in an initial state thereof wherein the parameters to be adjusted are not adjusted, there occurs the problem of a cross-erasure failure etc., wherein data recorded on the adjacent tracks is erased and thus the three-track recording for parameter adjustment itself, such as described in JP-1996-45081A, cannot be achieved

Accordingly, there is a critical problem in the optical disk as to how the parameters can be adjusted if there is no parameter adjustment signals recorded on the optical disk. In addition, even if there are recorded signals for the adjustment, there is another critical problem that which parameter is to be first adjusted is not known.

### SUMMARY OF THE INVENTION

It is therefore an object of the present invention to provide a data recording/reproducing device and a parameter adjusting method, which are capable of solving the above problems in the conventional techniques.

The present invention provides, in a first aspect thereof, a parameter adjustment method for adjusting a parameter defining a recording/reproducing condition for an information recording medium having a land/groove structure, which guides an optical spot, and capable of storing information data on both land and groove of the land/groove structure, the method including: the first step of trial-recording specific data on either adjacent three or more lands (L) or adjacent three or more grooves (G); and the second step of adjusting a radial tilt based on a reproduced signal of the data trial-recorded in the first step

The present invention provides, in a second aspect thereof, a parameter adjustment method for adjusting a parameter defining a recording/reproducing condition for an information recording medium having a land/groove disk structure, which guides an optical spot, and capable of storing information data on land or groove of the disk structure, the method including consecutively: the first step of trial-recording specific data on adjacent three or more tracks; the second step of adjusting a radial tilt based on a reproduced signal of the data recorded in the first step; and the third step of adjusting a focus offset based on a reproduced signal of the data recorded in the first step.

The present invention provides, in a third aspect thereof, a parameter adjustment method for adjusting a parameter defining a recording/reproducing condition for recording information data on an information recording medium, the method including consecutively: the first step of adjusting a radial tilt; and the second step of focusing a focus offset.

The present invention provides, in a fourth aspect thereof, an information recording/reproducing device which uses the above parameter adjustment methods of the present invention.

In accordance with the parameter adjustment method of the first aspect of the present invention, since a configuration is employed wherein specific data is trial-recorded on either the adjacent three lands or adjacent three grooves configuring three tracks, cross-talk occurring in the reproduced signal can be reduced during the adjustment of the radial tilt using the reproduced signal, whereby the radial tilt can be adjusted s with a higher accuracy. It is to be noted that the specific data may be data determined in advance or data generated at random.

In accordance with the parameter adjustment method of the second and third aspects of the present invention, since the configuration is employed wherein adjustment of the radial tilt and adjustment of focus offset are performed consecutively, an adjustment achieving a higher accuracy for the obtained parameters can be attained.

In the parameter adjustment method of the first aspect of the present invention, it is preferable that the first step perform the trail-recording on a track after data is already stored on an adjacent track, and the second step reproduce the trial-recorded data from the tracks in a state where the adjacent track stores thereon data.

It is also a preferable configuration that the second step include the steps of measuring a signal quality while changing the radial tilt; and selecting a radial tilt based on a relationship obtained in the measuring step between the radial tilt and the signal quality.

It is preferable that a signal-to-noise ratio (PRSNR) in partial response maximum likelihood be used as the signal quality.

It is also preferable to further include, succeeding to the second step, the third step of adjusting a focus offset.

It is also preferable to further include, succeeding to the third step, the fourth step of adjusting a recording power for use in recording information data.

It is also preferable to further include the fifth step of adjusting a track offset.

In the parameter adjustment method of the second aspect of the present invention, it is preferable that the first step perform the trail-recording on the tracks after data is already stored on an adjacent track, and the second step reproduce the trial-recorded data from the tracks in a state where the adjacent track stores data.

In addition, it is also preferable that the second step include the steps of measuring a signal quality while changing the radial tilt; and selecting a radial tilt based on a relationship obtained in the measuring step between the radial tilt and the signal quality.

It is preferable that a PRSNR be used as the signal quality in the second step.

It is also preferable to further include, succeeding to the third step, the fourth step of adjusting a recording power for use in recording information data.

It is also preferable to further include, succeeding to the fourth step, the fifth step of adjusting a track offset.

In the parameter adjustment method of the third aspect of the present invention, it is preferable to include, succeeding to the second step, the third step of adjusting a focus offset, thereafter, the fourth step of adjusting a recording power for recording information data, and thereafter, the fifth step of adjusting a track offset.

### BRIEF DESCRIPTION OF THE DRAWINGS

FIG. 1 is a block diagram of a data recording/reproducing device according to an embodiment of the present invention.

FIG. 2 is a chart showing a five-track recorded state.

FIG. 3 is a table showing the signal-to-noise ratio (PRSNR) in “partial response maximum likelihood” in the five-track recorded state in the situation where the radial tilt is deviated and not deviated from the optimum position.

FIG. 4 is a top plan view which exemplifies a three-track recorded state used in the present invention.

FIG. 5 is a table which exemplifies the PRSNR obtained from the three-track record used in the present invention in the situation where the radial tilt is deviated from and not deviated from the optimum position.

FIG. 6 is a graph which exemplifies the radial tilt dependency of PRSNR obtained from five-track record, three-track record used in the present invention, and single-track record.

FIG. 7 is a top plan view of a single-track recorded state.

FIG. 8 is a graph which exemplifies the radial tilt dependency of the optimum focus offset position.

FIG. 9 is a graph which exemplifies the radial tilt dependency of the optimum radial tilt position.

FIG. 10 is a table showing the recording power under the conditions of presence of a radial tilt, presence of a focus offset, and the optimum radial tilt and focus offset.

FIG. 11 is a flowchart showing the procedure in the parameter adjusting process of the embodiment of the present invention.

FIG. 12 is a graph showing the PRSNR obtained by the recording power adjustment of step 1 in the first example.

FIG. 13 is a graph showing the PRSNR obtained by the radial tilt adjustment of step 3 in the first example.

FIG. 14 is a graph showing the PRSNR obtained by the focus offset adjustment of step 4 in the first example.

FIG. 15 is a graph showing the PRSNR obtained by the recording power adjustment for the data recording of step 5 in the first example.

FIG. 16 is a top plan view showing the track recording method used in the track offset adjustment of step 6 in the first example.

FIG. 17 is a graph showing the PRSNR obtained by the track offset adjustment of step 6 in the first example.

FIG. 18 is a table showing the PRSNR obtained during recording/reproducing using learned parameters obtained in the first example and the optimum position of the parameters.

FIG. 19 is a top plan view showing the recorded state by using three-track record in the conventional parameter adjusting method.

FIG. 20 is a graph showing the radial tilt dependency of the PRSNR obtained from the track-recorded state shown in FIG. 19.

FIG. 21 is a table showing the learned parameters obtained in the second example and the PRSNR obtained by recording/reproducing at the optimum recording position while comparing both against one another.

FIG. 22 is a table showing the learned parameters obtained by the conventional adjustment method and the PRSNR obtained by recording/reproducing at the optimum recording position.

### BEST MODE FOR CARRYING OUT THE INVENTION

Before describing an embodiment of the present invention, the principle of the present invention will be described for a better understanding of the present invention.

It is assumed here that the optical disk is such that a land/groove structure is formed on a single surface of the optical disk and that the format is such that recording of the information data is performed on both the protrusion and depression of the land/groove structure. There may be a case where the optical head is located on the disk surface on which the protrusions and depressions are formed or another case where the optical head is located on the opposite disk surface. The former case is referred to as a film-surface incident type, and the latter case is referred to as a substrate-surface incident type. Since the film-surface incident type was developed at the beginning, the depression in the land/groove structure was referred to as groove and the protrusion was referred to as land. However, since the current optical disk employs a substrate-surface incident type, the depression and protrusion of the land/groove structure appear to be opposite in the substrate-surface incident type. Although the depression should be referred to as groove and the protrusion should be referred to as land in disk of the substrate-surface incidence type as well, the appellative is based on the structure of the disk itself, wherein depression and protrusion are referred to as land and groove, respectively, in the substrate-surface incidence type.

More specifically, the depression and protrusion of the land/groove structure, as observed from the optical head, are referred to as land (L) and groove (G), respectively, in this optical disk. The format in which information data is recorded on both the land and the groove is referred to as land/groove format, and the format in which information data is recorded only on the groove is referred to as in-groove format. The optical disk standards employing the land/groove format include DVD-RAM, HD DVD-RW, etc. On the other hand, the optical disk specifications employing the in-groove format include DVD-R, DVD-RW, HD DVD-R, etc.

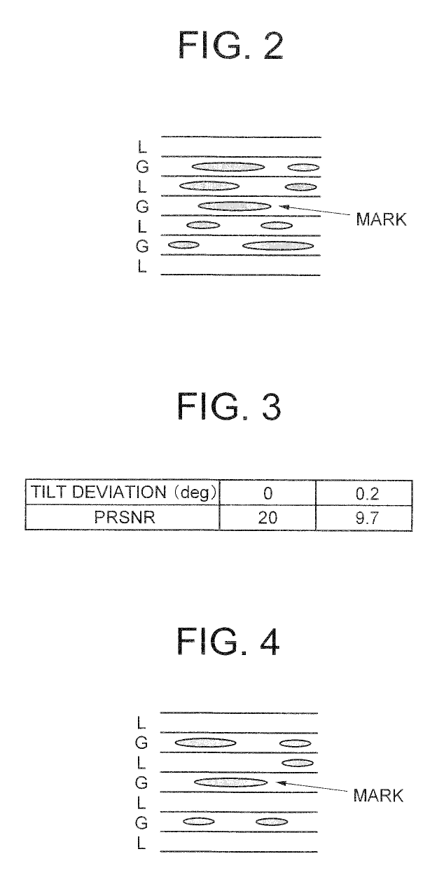

It is assumed here that a five-track record such as shown in FIG. 2 is performed on a HD DVD-RW. In this situation, the PRSNR value determined from the reproduced signal was experimentally measured for the case where the radial tilt is at the optimum position, and another case where the radial tilt is deviated by 0.2 degree (deg) from the optimum position, and is shown in the table of FIG. 3 for comparison. Here, the PRSNR is a signal quality evaluation index, which replaces the jitter and employed in the HD DVD family. This means a SNR in the PRML (Partial Response Maximum Likelihood). A higher PRSNR value is deemed to correspond to a higher signal quality. The detail of PRSNR is described in “Japanese Journal of Applied Physics Vol. 43, No. 7B, 2004, pp. 4859-4862, “Signal-to-Noise Ratio in a PRML Detection” S. OHKUBO et al”.

If a five-track record is performed in the situation wherein the radial tilt is deviated by 0.2 degree, the PRSNR is less than 10, as understood from FIG. 3. This is due to occurrence of the phenomenon of cross-erasure, wherein recording on the adjacent track erases the recorded signal already recorded.

Upon adjusting a parameter, unless the index to be used for the adjustment corresponds to data recorded under an optimum condition, the optimum position for the parameter cannot be detected. This is because the optimum position should be obtained for the data recorded in an excellent condition. If the signal quality is excessively poor, the signal quality is degraded before the degradation caused by the change of parameter, and the contribution by the change of parameter is too small, whereby the optimum position is difficult to achieve.

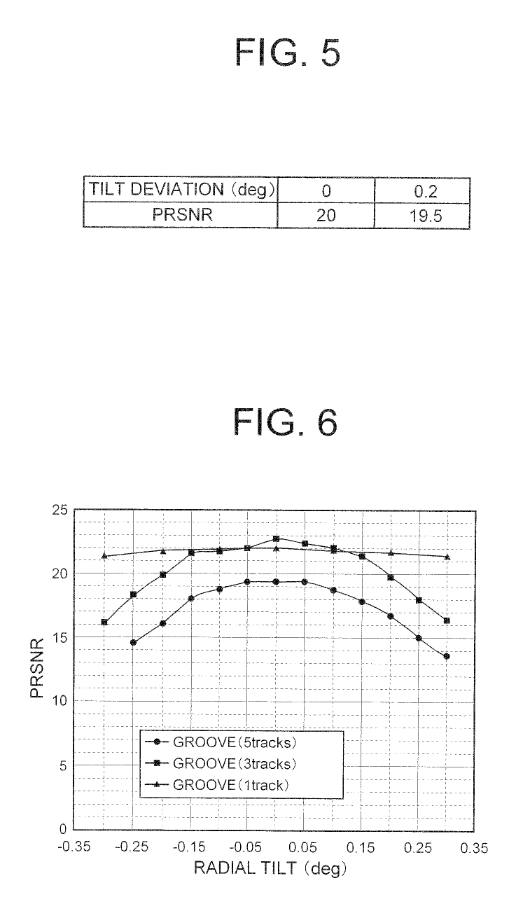

After a disk is first inserted in the optical disk drive, a situation often arises wherein the radial tilt is deviated by around 0.2 degree from the optimum position, whereby it is impossible to prepare a parameter adjustment signal in this situation. Thus, the present inventor performed three-track recording such as shown in FIG. 4. The three-track recording is such that the adjustment data is recorded only on the adjacent three grooves, or only on the adjacent three grooves. The PRSNR was measured for the three-track record in the case of the radial tilt residing at the optimum position and the case of the radial tilt deviating from the optimum position by 0.2 degree, and is shown in FIG. 5 for comparison. As understood from FIG. 5, the PRSNR is almost the same between them. Thus, it will be understood that the three-track record, if formed as shown in FIG. 4, allows an adjustment using at least an excellent recorded signal.

On the other hand, since an ordinary recorded state may be deemed as a five-track recorded state such as shown in FIG. 2, it is uncertain whether or not a suitable radial tilt can be detected from the three-rack recorded state as shown in FIG. 4. In view of this, the radial tilt dependency of the PRSNR was measured as to both the states of recording track shown in FIGS. 2 and 4. The results are shown in FIG. 6, from which it will be understood that the radial tilt position at which the PRSNR assumes the maximum (optimum radial tilt position) does not differ between the three-track record according to the present invention and the five-track record showing the ordinary recorded state. More specifically, the three-track recorded state according to the present invention provides adjustment of the radial tilt at the optimum value.

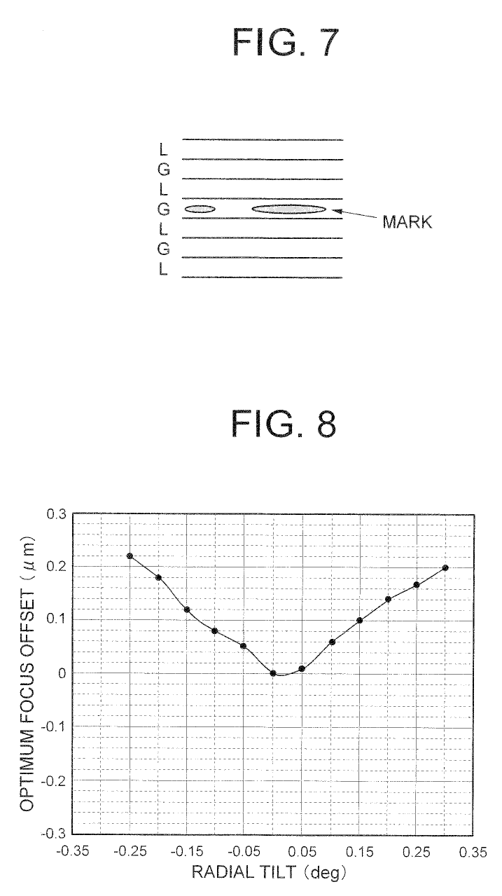

FIG. 6 also shows the results in the case of a single-track record such as shown in FIG. 7 for comparison. It is understood from FIG. 6 that there is little radial tilt dependency of PRSNR in the single-track record, and a suitable adjustment is difficult to achieve. Therefore, after an optical disk is first inserted in the drive, it is optimum to perform three-track recording such as shown in FIG. 4, and to adjust the radial tilt. It is to be noted that the three-track record wherein only three adjacent grooves are subjected to the recording may be replaced by another three-track record wherein only three adjacent lands are subjected to the recording, in order to adjust the radial tilt.

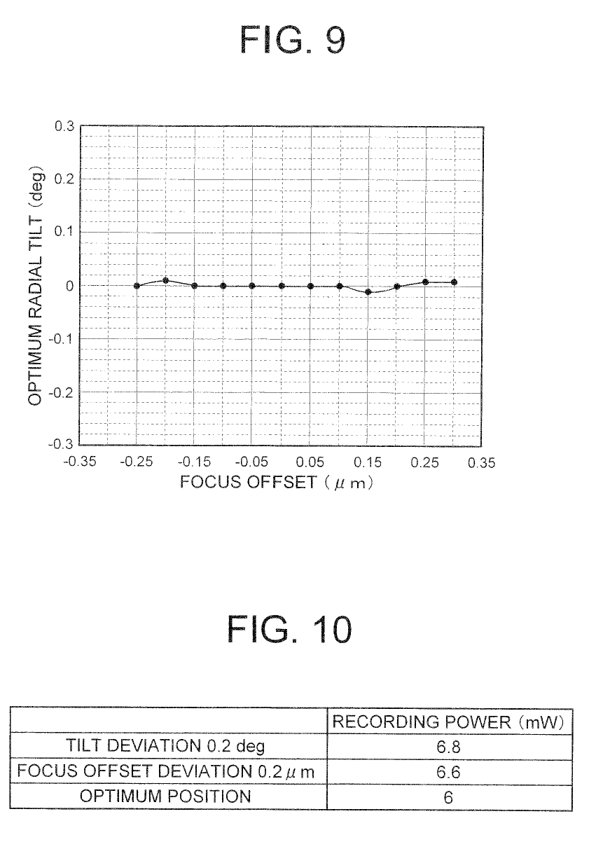

FIG. 8 shows the relationship between the radial tilt and the optimum position of the focus offset. The optimum position of the focus offset significantly depends on the radial tilt. FIG. 9 shows the focus offset dependency of the optimum position of the radial tilt. The optimum position of the radial tilt scarcely depends on the focus offset. It will be understood from the above facts that upon the parameter adjustment, it is important to first adjust the radial tilt and thereafter adjust the focus offset in the relationship between the radial tilt and the focus offset.

FIG. 10 shows the results of determining the optimum recording power in the three cases including a case wherein only the radial tilt was deviated by 0.2 degree from the optimum position, a case where only the focus offset was deviated from the optimum position by 0.2 micrometer, and a case where both the parameters were at the optimum position. The optimum recording power is obtained as a recording power at which the PRSNR assumed a maximum under the respective conditions. It is understood from FIG. 10 that the optimum recording power is higher in the case where the radial tilt and focus offset are deviated from the optimum position than in the case where they are at the optimum position. That is, it is understood that the optimum recording power should be adjusted after the radial tilt and defocus are adjusted.

Since the remaining last parameter is the track offset, this is finally adjusted to complete adjustment of all the parameters. Although omitted in the above description, the tangential tilt may be adjusted after the adjustment of the radial tilt and focus offset because the tangential tilt is often matched in general.

The above adjustment method is described in the case of land/groove format. On the other hand, the recorded state in the case of in-groove format is the three-track recorded state due to the nature thereof Also in this case, it is expected preferable from the results shown in FIGS. 8 to 10 that the adjustment be performed in the order of radial tilt, focus offset, information data recording power adjustment, and track offset.

Since the recording power used for trial recording performed after the optical disk is first inserted in the optical disk drive may be improper, a simple adjustment processing therefor may be possibly provided before the radial tile adjustment or defocus adjustment. However, the adjustment of the recording power for information data (final recording power adjustment) is performed finally after the adjustment of radial tilt and focus offset.

It is to be noted that although the parameter adjustment using measurement of the PRSNR is described, the parameter adjustment is not limited thereto, and jitter may be measured. Since the PRSNR and jitter have therebetween a high correlation, use of the jitter will provide a similar effect.

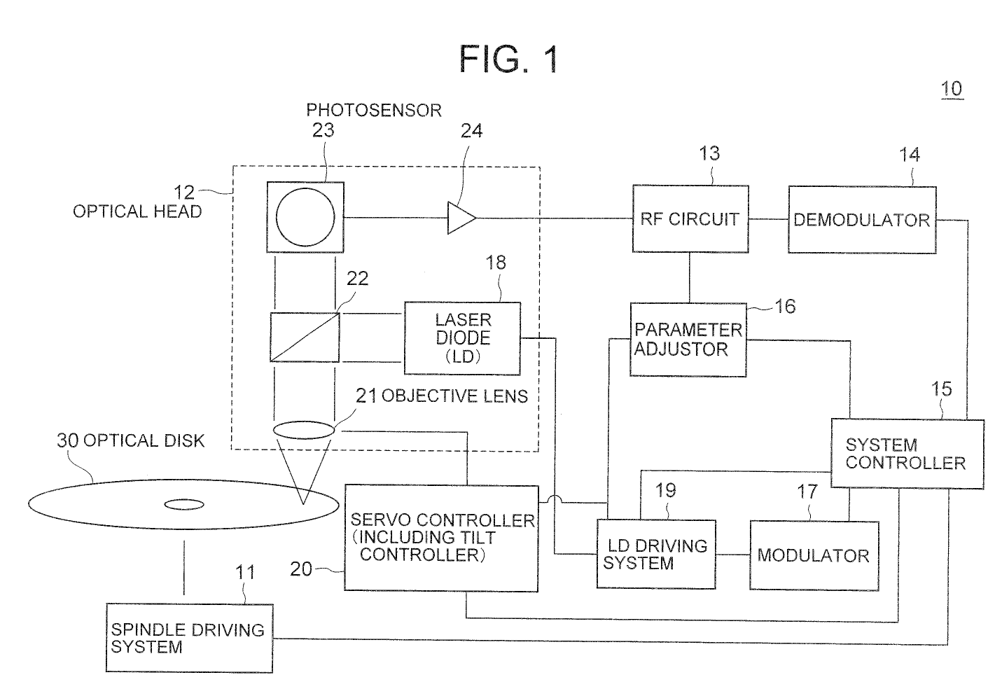

Hereinafter, an embodiment of the present invention will be described in detail with reference to drawings. FIG. 1 shows a block diagram of a data recording/reproducing device according to an embodiment of the present invention. The data recording/reproducing device 10 is comprised of a spindle driving system 11 for driving an optical disk 30, an optical head 12 for irradiating the optical disk 30 with a laser beam to detect the same, a RF circuit block 13 for performing processing of the input signal such as filtering, a demodulator 14 for demodulating the input signal, a system controller 15 for performing overall control of the whole device, a parameter adjuster 16 for performing adjustment of parameters, a modulator 17 for modulating the signal to be recorded, a laser diode (LD) 18, a LD drive system 19 for driving the LD 18, a servo controller 20 for controlling servo signals and performing the tilt control, and a beam splitter 22 for reflecting the light from the LD18 toward an objective lens 21 and passing the reflected from the optical disk 30 toward a photosensor 23. The parameter adjuster 16 is used for adjusting a variety of parameters according to the present invention. The calculation of PRSNR is performed from the reproduced signal in the RF circuit block 13.

### FIRST EXAMPLE

In this example, an optical head 12 having a LD wavelength of 405 nm and a NA (numerical aperture) of 0.65 was prepared. An optical disk 30 was prepared wherein the land/groove structure for use in the land/groove format was provided on a polycarbonate substrate having a diameter of 120 mm and a thickness of 0.6 mm. As the density of data recorded, a bit pitch of 0.13 micrometer and a track pitch of 0.34 micrometer were selected. A phase-change recording film of the rewritable type wherein the recording is performed by phase change was used therein.

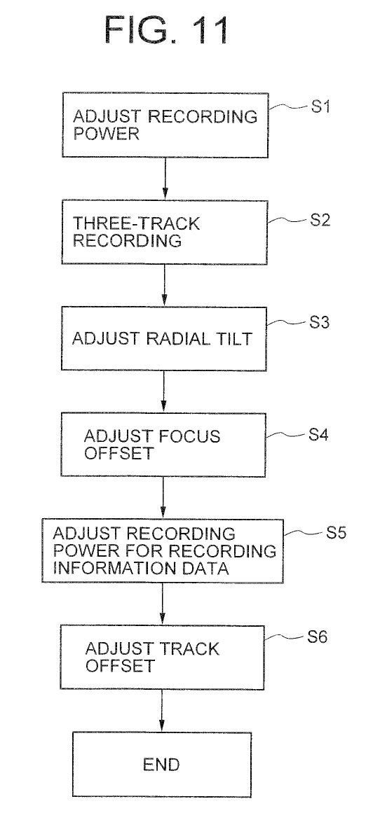

FIG. 11 shows the processing flow in the parameter adjuster 16. The processing by the parameter adjuster 16 in the present embodiment includes step 1 of adjusting the recording power, step 2 of performing a three-track record of random data onto adjacent three grooves or adjacent three lands, step 3 of adjusting the radial tilt, step 4 of adjusting the focus offset, step 5 of adjusting the data recording power, and step 6 of adjusting the track offset.

In the parameter adjustment method of the present embodiment, a processing for adjusting the recording power is inserted before the radial tilt adjustment and focus offset adjustment as a parameter adjustment processing. In general, adjustment of the radial tilt and focus offset will change the suitable recording power to some extent. Therefore, in order to perform adjustment using the optimum PRSNR, the recording power may be adjusted at any time after the adjustment of those parameters. If the optimum recording power can be estimated in advance for the optimum parameters of the optical disk, it is also possible to set a recording power higher than the optimum recording power, form a recorded signal by using the thus set recording power, and adjust the radial tilt and focus offset from the reproduced signal obtained therefrom.

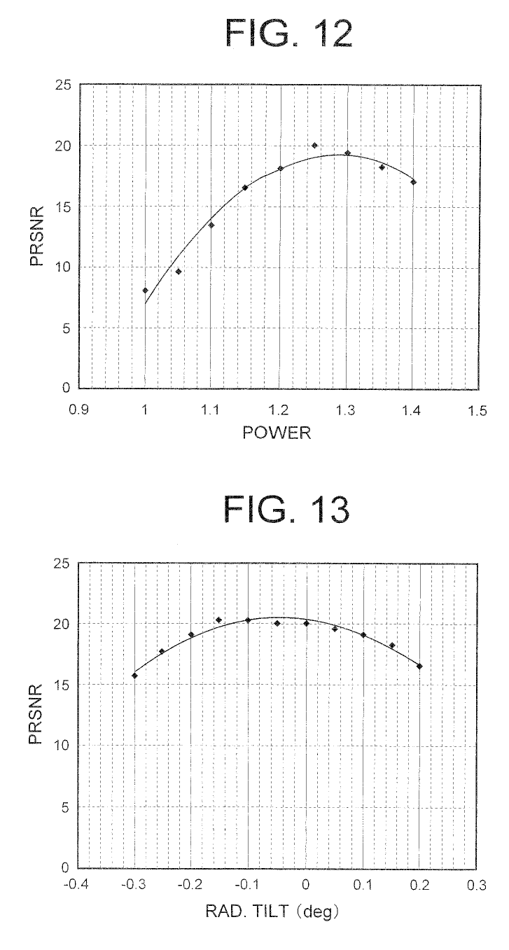

In this example, in order to demonstrate the advantages of the present invention, the parameter adjustment was performed from initial values by using the process shown in FIG. 11, the initial values being such that the radial tilt, focus offset and land track offset are deviated from the optimum parameter position by 0.2 degree, 0.2 micrometer, and 0.01 micrometer, respectively. First, the recording power was adjusted in step 1 while measuring the PRSNR. FIG. 12 shows the recording power dependency of the PRSNR shown in the adjustment at this stage. A normalized recording power is plotted on abscissa, whereas the PRSNR measured is plotted on ordinate. The “1” plotted on the abscissa means the optimum recording power in the case of all the other parameters being at the optimum position. Since the radial tilt and focus offset were deviated from the optimum position, the optimum recording power adjusted at this stage was at 1.28 which was somewhat higher. The optimum recording power was obtained from a peak point of a secondary function, which approximated the measurements of PRSNR at respective recording powers. Since the optical disk used in this example had a similar recording sensitivity on both the land and groove, the adjustment may be performed at any of them.

The optimum recording power as obtained above was used in step 2 to perform a three-track recording according to the present invention. The recording was performed to the groove in this example. Thereafter, in step 3, the central track was selected among the three tracks subjected to the recording in step 2, the PRSNR was measured while changing the radial tilt to adjust the radial tilt. FIG. 13 shows the results thereof The optimum tilt thus obtained was at 31 0.04 degree. Since the optimum parameter position of the radial tilt is at 0.0 degree, it will be understood therefrom that the adjustment was performed with an excellent accuracy.

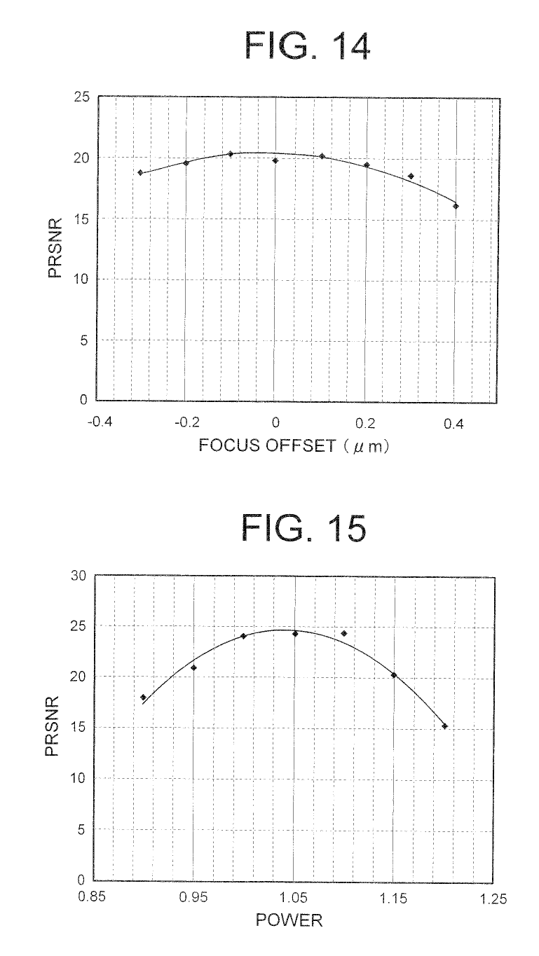

Thereafter, the focus offset was adjusted in step 4 similarly to step 3. FIG. 14 shows the results thereof. The optimum focus offset thus obtained was at 31 0.02 micrometer. Since the optimum parameter position of the focus offset is at 0.0 micrometer, it will be understood that the adjustment was performed with an excellent accuracy.

Thereafter, adjustment of the recording power for use in actual recording was performed in step 5. FIG. 15 shows the recording power dependency of the PRSNR used in the adjustment. It will be understood from the same drawing that the optimum recording power is at 1.04. Since the optimum recording power in the case of all the other parameters being at the optimum position is at “1”, it will be understood that the adjustment is performed with an excellent accuracy. Although a second adjustment is performed with respect to the recording power in the processing of this step, this step is the final adjustment and this recording power is used for recording the information data.

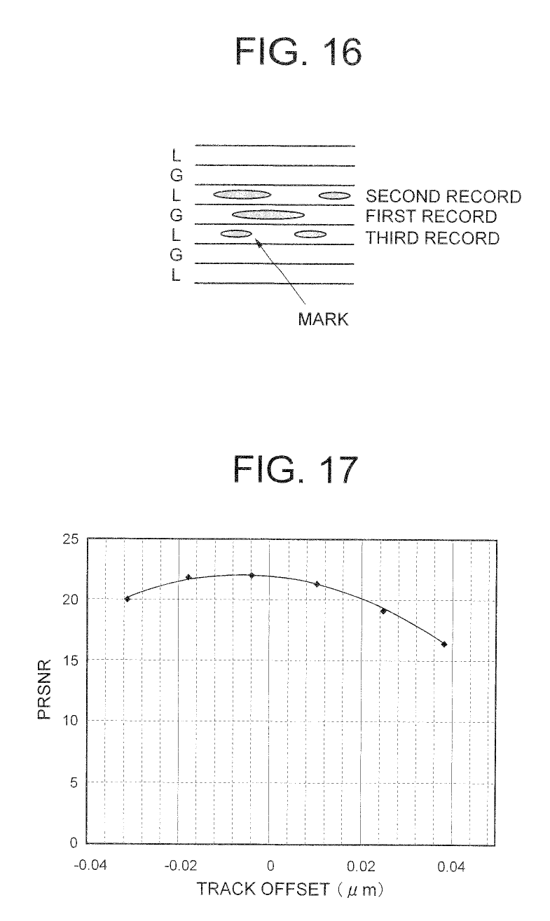

Thereafter, adjustment of the track offset was performed in step 6. In this adjustment, as shown in FIG. 16, the central groove is first subjected to the recording among the adjacent three tracks configured by the adjacent grooves, followed by recording onto both the lands adjacent to the groove. Subsequently, the central groove is subjected to measurement of the PRSNR on the central groove. This process was performed while changing the track offset of the lands, revealing the results shown in FIG. 17. From FIG. 17, the optimum track offset of the land is at −0.004 micrometer. Since the optimum parameter position of track offset of the land is at 0.0 micrometer, it is understood therefrom that the adjustment was performed with an excellent accuracy.

Due to use of the data recording/reproducing device according to the above embodiment, all the parameters needed for recording/reproducing were adjusted in a superior way to record the information data, even if the adjustment parameters are not recorded on the optical disk etc.

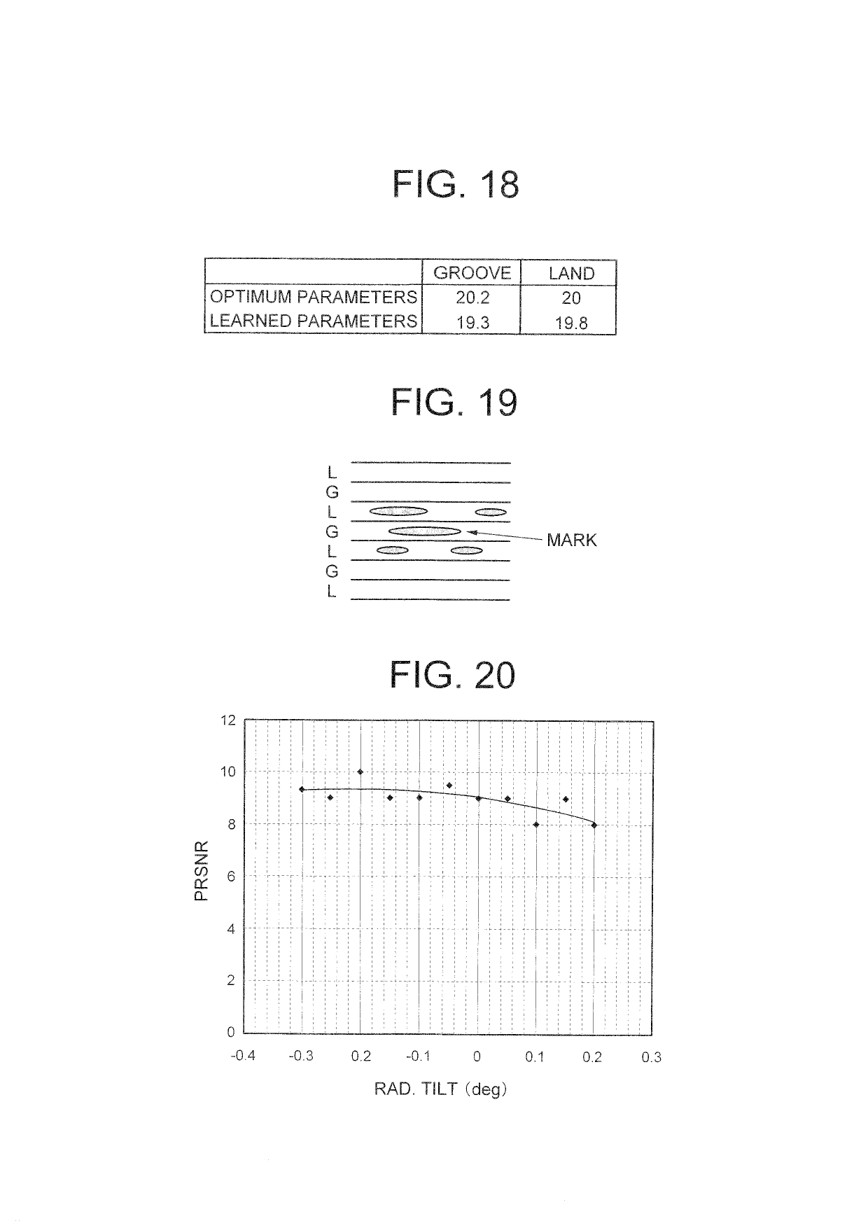

For assuring the advantages of the first example, values of the PRSNR were compared between a case where the recording was performed using the parameter values obtained in the above adjustment and another case where the recording was performed with all the parameter values being at the optimum position. FIG. 18 shows the results thereof. Both have comparable PRSNR, thereby showing the reliability of the data recording/reproducing device of the present invention.

As a reference, random recording was conducted onto adjacent three tracks including lands and grooves similarly to the conventional technique, and differently from the above example performing the three-track recording onto only grooves or only lands, thereby preparing record such as shown in FIG. 19, based on which the radial tilt was adjusted. FIG. 20 shows the data obtained by the adjustment. Since the values of PRSNR were extremely low and also the rate of change was also low with respect to the radial tilt, the adjusted radial tilt was at −0.2 degree, and thus not well adjusted. In the combination of the optical disk and the optical disk drive, as used in the first example, the PRSNR value hardly changes with respect to the radial tilt in the three-track record shown in FIG. 19. This is because the rise of cross-talk caused by the radial tilt is small and the PRSNR is not deteriorated unless the three-track record shown in FIG. 4 is not used.

### SECOND EXAMPLE

By using the data recording/reproducing device used in the first example, an optical disk having an in-groove format was subjected to the adjustment similarly to the first example. The optical head had a LD wavelength of 405 nm and a NA of 0.65. The optical disk was prepared wherein a land-groove structure having an in-groove format is formed on the polycarbonate substrate having a diameter of 120 mm and a thickness of 0.6 mm. The density of data recorded was such that the bit pitch was 0.153 micrometer and the track pitch was 0.4 micrometer. An organic-dye recording film was used as the recording film wherein recording is performed by deformation. This is a write-once-type disk.

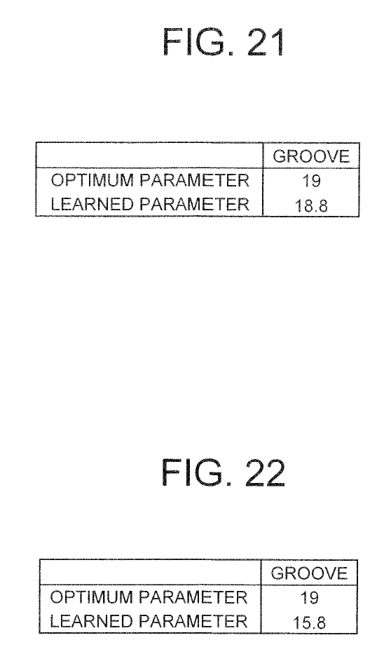

Also in this example, the adjustment method shown in FIG. 11 was employed. Adjustment was performed from the initial values similar to those in the first example, the data thus obtained was deemed as learned parameter, the data wherein all the parameters were at the optimum position was deemed as the optimum parameters, and the PRSNR obtained from these parameters was compared with respect to only the grooves between both the groups similarly to the case of FIG. 18. FIG. 21 shows the results thereof. Both represent a comparable PRSNR, thereby assuring the reliability of the data recording/reproducing device of the present invention.

A comparative method is used in place of the adjustment method of FIG. 11, to perform similar processings while reversing the order of the radial tilt adjustment and focus offset adjustment shown in FIG. 11. The PRSNR was compared similarly to FIG. 21 based on the thus lo obtained parameters. FIG. 22 shows the results thereof. It will be understood that the PRSNR after the adjustment is low and thus the adjustment is not sufficient. This is because the optimum position of the focus offset depends on the radial tilt, and it will be understood that the procedure having a reversed order cannot afford an optimum value for all the parameters. Thus, the effectiveness of the device and adjustment method of the present invention can be ascertained.

In the parameter adjustment method of the present invention, the LD wavelength and NA are not limited to 405 nm and 0.6, respectively, and the present invention can be adapted to any wavelength and any NA. In addition, although a record signal is not present between the lands or between the grooves in the case of recording onto only the grooves or only the lands in the above embodiment, it is possible that record mark may exist on the track between the lands or between the grooves before performing the three-track recording only on the lands or only on the grooves. It is important that the adjustment data is recorded on the tracks to be used for the measurement after recording on the tracks adjacent to the tracks to be used for the measurement.

Although the description is directed to an example wherein the optical disk to which the present invention is applied is a reflective-type optical disk, the method of the present invention can be applied to a transmissive-type optical disk as well.

### INDUSTRIAL APPLICABILITY

The present invention can be used widely as the recording/reproducing device and a parameter adjustment method for a high-density optical disk in particular.

1-20. (canceled)

21. A parameter adjustment method for adjusting a parameter defining a recording/reproducing condition for an information recording medium having a land/groove structure, which guides an optical spot, and capable of storing information data on both land and groove of said land/groove structure, said method comprising:
trial-recording specific data on either adjacent three or more lands or adjacent three or more grooves; and
adjusting a radial tilt based on a reproduced signal of said trial-recorded specific data.

22. The parameter adjustment method according to claim 21, wherein said trail-recording performs recording in a state where data is recorded on an adjacent track adjacent to said three of more lands or three or more grooves, and said radial tilt adjusting includes reproducing said trial-recorded data from said three or more lands or three or more grooves in a state where said adjacent track stores thereon said recorded data.

23. The parameter adjustment method according to claim 21, wherein said radial tilt adjusting comprises measuring a signal quality while changing said radial tilt; and selecting a specific radial tilt based on a relationship obtained in said measuring step between said radial tilt and said signal quality.

24. The parameter adjustment method according to claim 21, wherein a signal-to-noise ratio (PRSNR) in partial response maximum likelihood is used as said signal quality.

25. The parameter adjustment method according to claim 21, further comprising, succeeding to said radial tilt adjusting, adjusting a focus offset.

26. The parameter adjustment method according to claim 25, further comprising, succeeding to said focus offset adjusting, adjusting a recording power for use in recording information data.

27. The parameter adjustment method according to claim 26, further comprising, succeeding to said recording power adjusting, adjusting a track offset.

28. A parameter adjustment method for adjusting a parameter defining a recording/reproducing condition for an information recording medium having a land/groove disk structure, which guides an optical spot, and capable of storing information data on land or groove of said disk structure, said method comprising consecutively:
trial-recording specific data on adjacent three or more tracks;
adjusting a radial tilt based on a reproduced signal of said recorded specific data; and
adjusting a focus offset based on a reproduced signal of said trial-recorded specific data.

29. The parameter adjustment method according to claim 28, wherein said trail-recording performs on said tracks in a state where data is recorded on a first track adjacent to said three or more tracks, and said radial tilt adjusting reproduces said trial-recorded data from said three or more tracks in a state where said first track stores thereon said recorded data.

30. The parameter adjustment method according to claim 28, wherein said radial tilt adjusting comprises measuring a signal quality while changing said radial tilt; and selecting a radial tilt based on a relationship obtained in said measuring between said radial tilt and said signal quality.

31. The parameter adjustment method according to claim 28, wherein a signal-to-noise ratio (PRSNR) in partial response maximum likelihood is used as said signal quality in said second step.

32. The parameter adjustment method according to claim 28, further comprising, succeeding to said focus offset adjusting, adjusting a recording power for use in recording information data.

33. The parameter adjustment method according to claim 32, further comprising, succeeding to said recording power adjusting, adjusting a track offset.

34. A parameter adjustment method for adjusting a parameter defining a recording/reproducing condition for recording information data on an information recording medium, said method comprising consecutively: adjusting a radial tilt; and focusing a focus offset

35. The parameter adjustment method according to claim 34, further comprising, succeeding to said radial tilt adjusting, adjusting a focus offset

36. The parameter adjustment method according to claim 35, further comprising, succeeding to said focus offset adjusting, adjusting a recording power for recording information data.

37. The parameter adjustment method according to claim 36, further comprising, succeeding to said recording power adjusting, adjusting a track offset.

38. An information recording/reproducing device which uses the parameter adjustment method according to claim 21.

39. An information recording/reproducing device which uses the parameter adjustment method according to claim 28.

40. An information recording/reproducing device which uses the parameter adjustment method according to claim 34.
